(19) United States
(12) Patent Application Publication
(10) Pub. No.: US 2025/0279801 A1
(43) Pub. Date: Sep. 4, 2025

(54) COMMUNICATION DEVICE

(71) Applicant: TOSHIBA TEC KABUSHIKI KAISHA, Tokyo (JP)

(72) Inventor: Naohiro Matsushita, Mishima Shizuoka (JP)

(21) Appl. No.: 18/923,733

(22) Filed: Oct. 23, 2024

(30) Foreign Application Priority Data
Mar. 1, 2024 (JP) 2024-031187

(51) Int. Cl. H04B 1/50; H04B 1/04; H04B 1/10

(52) U.S. Cl. CPC H04B 1/50; H04B 1/0458; H04B 1/10

(57) ABSTRACT

A communication device includes an antenna; a first generation unit; a duplexer; a second generation unit; a suppression unit; a first detection unit; and an adjustment unit. The duplexer receives the carrier wave generated by the first generation unit from an input terminal and outputs the carrier wave to the antenna from an input and output terminal, and outputs a signal input from the antenna to the input and output terminal from an output terminal. The second generation unit generates a cancel signal by changing an amplitude and a phase of the carrier wave. The suppression unit suppresses a self-interference signal in an output signal from the output terminal by using the cancel signal. The first detection unit detects a mismatching state of impedance matching related to the antenna. The adjustment unit adjusts, in response to detection of the mismatching state, an antenna impedance to eliminate the mismatching state.

### CROSS-REFERENCE TO RELATED APPLICATION

This application is based upon and claims the benefit of priority from Japanese Patent Application No. 2024-031187, filed on Mar. 1, 2024, the entire contents of which are incorporated herein by reference.

### FIELD

Embodiments described herein relate to a communication device, a communication method, and an RFID reading device.

### BACKGROUND

In a communication device that shares an antenna for transmission and reception, a part of a transmitted signal may be superimposed on a received signal and flow into a reception system. A transmitted signal component superimposed on the received signal becomes a self-interference signal, and there is a concern that communication quality may be degraded due to saturation of the reception system and an increase in noise.

Therefore, a technique is known in which a cancel signal having a phase opposite to that of the self-interference signal is generated based on the transmitted signal, and the self-interference signal is cancelled using the cancel signal.

The self-interference signal varies depending on a surrounding environment. Therefore, before receiving a response signal from a wireless tag, a carrier wave is transmitted to generate a self-interference signal, and a cancel signal is adjusted so as to effectively cancel the self-interference signal.

However, variations in an antenna impedance due to changes in the surrounding environment cause variations in the self-interference signal, and the self-interference signal may not be appropriately cancelled by the adjusted cancel signal.

### DESCRIPTION OF THE DRAWINGS

FIG. 1 is a block diagram showing a circuit configuration of a reading device according to an embodiment;

FIG. 2 is a block diagram showing a circuit configuration of main parts of a matching adjustment unit;

FIG. 3 is an immittance chart showing adjustment amounts of a plurality of matching circuits;

FIG. 4 is a flowchart of controlling;

FIG. 5 is a flowchart of controlling;

FIG. 6 is a diagram showing an actual measurement example of variations in a phase of a reflected signal over time; and

FIG. 7 is a diagram showing an actual measurement example of a change in cancellation amount due to a phase error.

### DETAILED DESCRIPTION

Under the circumstances described above, it is desired to appropriately cancel the self-interference signal even if the antenna impedance varies. Therefore, in general, according to one embodiment, a communication device that is capable of appropriately cancelling a self-interference signal even if an antenna impedance varies is provided.

According to one embodiment, a communication device for receiving a response wave emitted from a wireless tag based on a received carrier wave includes an antenna, a first generation unit, a duplexer, a second generation unit, a suppression unit, a first detection unit, and an adjustment unit. The first generation unit generates a carrier wave. The duplexer receives the carrier wave generated by the first generation unit from an input terminal and outputs the carrier wave to the antenna from an input and output terminal, and outputs a signal input from the antenna to the input and output terminal from an output terminal. The second generation unit generates a cancel signal by changing an amplitude and a phase of the carrier wave generated by the first generation unit. The suppression unit suppresses a self-interference signal in an output signal from the output terminal by using the cancel signal generated by the second generation unit. The first detection unit detects that impedance matching related to the antenna is in a predetermined mismatching state. The adjustment unit adjusts, in response to detection of the mismatching state by the first detection unit, an antenna impedance to eliminate the mismatching state.

Hereinafter, an embodiment will be described with reference to the drawings. In the following description, a reading device that reads data stored in a radio frequency identification (RFID) tag will be described as an example. The reading device performs wireless communication with the RFID tag when reading the data, and is an example of a communication device. The RFID tag is an example of a wireless tag.

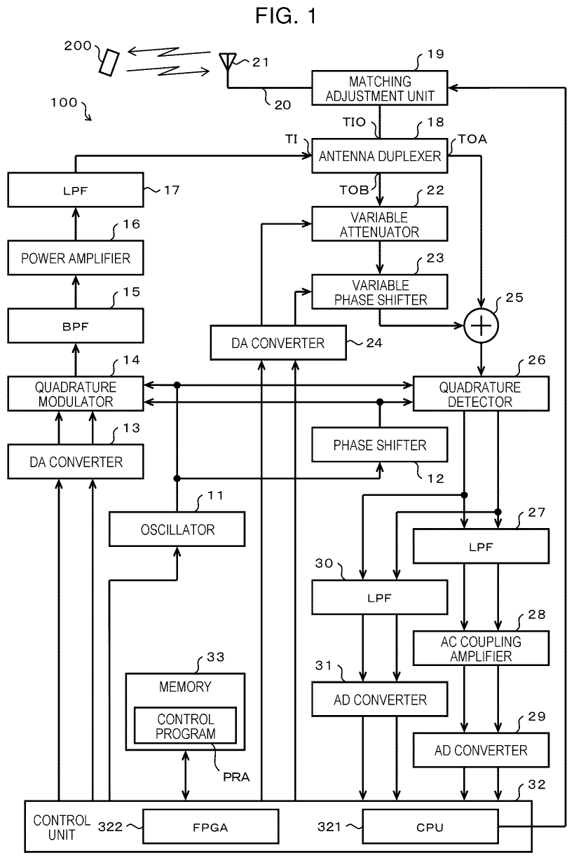

FIG. 1 is a block diagram showing a circuit configuration of a reading device 100 according to the embodiment.

The reading device 100 includes an oscillator 11, a phase shifter 12, a digital to analog (DA) converter 13, a quadrature modulator 14, a band-pass filter (BPF) 15, a power amplifier 16, a low-pass filter (LPF) 17, an antenna duplexer 18, a matching adjustment unit 19, a feed line 20, an antenna 21, a variable attenuator 22, a variable phase shifter 23, a DA converter 24, a power combiner 25, a quadrature detector 26, an LPF 27, an alternating current (AC) coupling amplifier 28, an analog to digital (AD) converter 29, an LPF 30, an AD converter 31, a control unit 32, and a memory 33. The control unit 32 includes a central processing unit (CPU) 321 and a field programmable gate array (FPGA) 322. The antenna 21, or the feed line 20 and the antenna 21 may not be in the reading device 100, and any separate device may be connectable.

The oscillator 11 generates a sine wave having a predetermined frequency as a carrier wave.

The phase shifter 12 shifts a phase of the carrier wave generated by the oscillator 11 by 90 degrees, and outputs a cosine wave as another carrier wave.

The oscillator 11 and the phase shifter 12 are examples of a first generation unit.

The DA converter 13 converts two-system transmitted baseband signals output in a digital state from the CPU 321 into analog signals. Hereinafter, the two-system transmitted baseband signals are referred to as an I signal and a Q signal, respectively.

The quadrature modulator 14 receives the I signal and the Q signal converted into analog signals by the DA converter 13 as modulated waves. The quadrature modulator 14 receives the carrier wave generated by the oscillator 11 and the carrier wave output from the phase shifter 12 as carrier waves of an I system and a Q system, respectively. The quadrature modulator 14 obtains a transmitted signal by quadrature modulation.

The BPF 15 removes a low-frequency component and a high-frequency component from the transmitted signal obtained by the quadrature modulator 14 for band limitation.

The power amplifier 16 amplifies power of the transmitted signal that passes through the BPF 15 to a level suitable for wireless transmission.

The LPF 17 removes a harmonic component from the transmitted signal amplified by the power amplifier 16.

The transmitted signal becomes a signal for wireless transmission by processing in the BPF 15, the power amplifier 16, and the LPF 17. That is, the BPF 15, the power amplifier 16, and the LPF 17 generate a transmitted signal for wireless transmission.

The antenna duplexer 18 includes an input terminal TI, an input and output terminal TIO, an output terminal TOA, and an output terminal TOB. The transmitted signal that passes through the LPF 17 is input to the input terminal TI. The antenna duplexer 18 outputs the transmitted signal input to the input terminal TI from the input and output terminal TIO and the output terminal TOB. The antenna duplexer 18 outputs a signal input to the input and output terminal TIO from the output terminal TOA. A signal output from the output terminal TOA of the antenna duplexer 18 is a signal obtained by combining a received signal generated in the antenna 21 and a self-interference signal to be described later.

Hereinafter the signal will be simply referred to as a received signal. The antenna duplexer 18 is an example of a duplexer.

The matching adjustment unit 19 matches an impedance of the antenna 21 within a predetermined control target range.

The feed line 20 supplies a transmitted signal output from the input and output terminal TIO of the antenna duplexer 18 to the antenna 21. The feed line 20 transmits a received signal generated in the antenna 21 to the input and output terminal TIO of the antenna duplexer 18.

The antenna 21 emits a radio wave corresponding to the transmitted signal supplied from the feed line 20. The antenna 21 generates an electrical signal corresponding to the incoming radio wave as a received signal.

The variable attenuator 22 attenuates a transmitted signal output from the output terminal TOB of the antenna duplexer 18 with a gain corresponding to a gain setting signal supplied from the DA converter 24.

The variable phase shifter 23 changes a phase of the transmitted signal attenuated by the variable attenuator 22 by a phase shift amount corresponding to a phase shift amount setting signal supplied from the DA converter 24. The transmitted signal after the phase shift by the variable phase shifter 23 is hereinafter referred to as a cancel signal.

Thus, the variable attenuator 22 and the variable phase shifter 23 serve as a second generation unit that generates the cancel signal.

The DA converter 24 converts gain setting data output from the control unit 32 into a gain setting signal in an analog state and supplies the gain setting signal to the variable attenuator 22. The DA converter converts phase shift amount setting data output from the control unit 32 into a phase shift amount setting signal in an analog state and supplies the phase shift amount setting signal to the variable phase shifter 23.

The power combiner 25 power combines a cancel signal output from the variable phase shifter 23 with a received signal output from the output terminal TOA of the antenna duplexer 18. Accordingly, the power combiner 25 reduces a self-interference signal in the received signal. The power combiner 25 is an example of a suppression unit.

The quadrature detector 26 performs quadrature detection on a received signal output from the power combiner 25 using the two carrier waves output from the oscillator 11 and the phase shifter 12. The quadrature detector 26 outputs two-system received baseband signals in an analog state obtained by quadrature detection in parallel.

The LPF 27 removes an unnecessary frequency component other than a baseband component from each of the two-system received baseband signals output from the quadrature detector 26.

The AC coupling amplifier 28 amplifies an AC component corresponding to a response wave while cutting a DC component of each of the two-system received baseband signals that pass through the LPF 27.

The AD converter 29 digitizes each of the two-system received baseband signals output from the AC coupling amplifier 28.

The LPF 30 removes a harmonic component in each of the two-system received baseband signals output from the quadrature detector 26.

The AD converter 31 digitizes each of the two-system received baseband signals output from the LPF 30.

The memory 33 stores an information processing program described for information processing to be executed by the CPU 321. One of the information processing programs stored in the memory 33 is a control program PRA related to a controlling to be described later. The memory 33 stores various types of data required for the CPU 321 to execute various types of information processing. The memory 33 stores various types of data generated or acquired when the CPU 321 executes various types of information processing.

When communicating with a RFID tag 200, the CPU 321 outputs the I signal and the Q signal according to a predetermined sequence. The CPU 321 reconstructs data sent from the RFID tag 200 based on two-system received signals digitized by the AD converter 29. The CPU 321 executes information processing to be described later for controlling the matching adjustment unit 19 or for adjusting a gain in the variable attenuator 22 and a phase shift amount in the variable phase shifter 23.

The FPGA 322 executes signal processing programmed in advance to execute various calculations associated with information processing by the CPU 321 at high speed. One of functions of the FPGA 322 is calculating a suppression amount of the self-interference signal due to the cancel signal, based on levels of the two-system received baseband signals digitized by the AD converter 31. One of the functions of the FPGA 322 is determining a magnitude of a return loss of the antenna 21, based on levels of the two-system received baseband signals digitized by the AD converter 31. The return loss of the antenna 21 is a ratio of a magnitude of power supplied to the antenna 21 to a magnitude of reflected power occurring at a feeding point of the antenna 21.

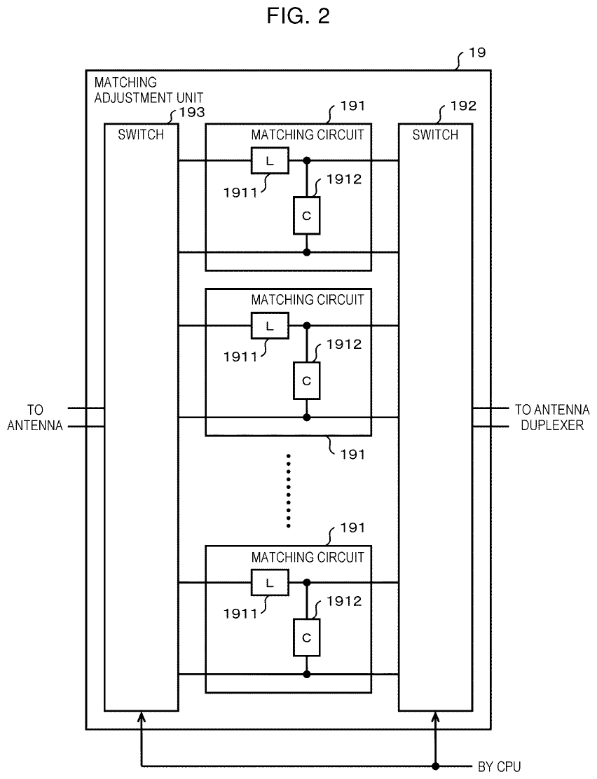

FIG. 2 is a block diagram showing a circuit configuration of main parts of the matching adjustment unit 19.

The matching adjustment unit 19 includes a plurality of matching circuits 191 and switches 192 and 193. The switches 192 and 193 insert one of the plurality of matching circuits 191 between the antenna duplexer 18 and the antenna 21 under control of the CPU 321. Each of the plurality of matching circuits 191 changes an antenna impedance when the matching circuit 191 is inserted between the antenna duplexer 18 and the antenna 21. Each of the plurality of matching circuits 191 includes an inductor 1911 connected in series between the antenna duplexer 18 and the antenna 21, and a capacitor 1912 connected in parallel between the antenna duplexer 18 and the antenna 21. The matching circuits 191 have different combinations of an inductance value of the inductor 1911 and a capacitance value of the capacitor 1912.

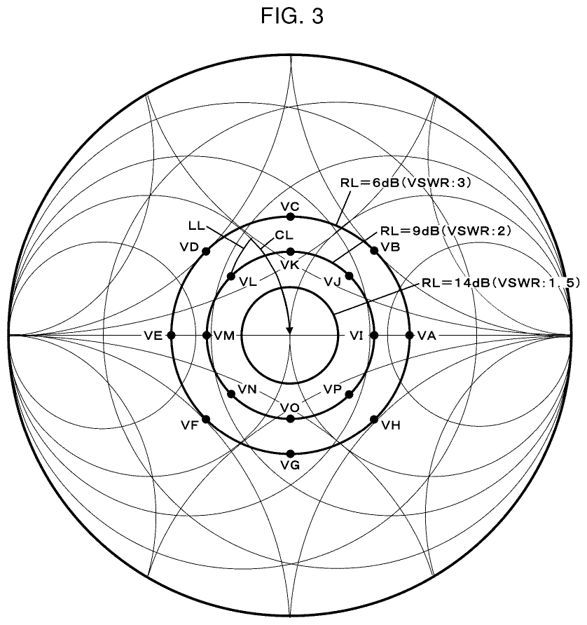

FIG. 3 is an immittance chart showing adjustment amounts of the plurality of matching circuits 191.

As an example, the number of matching circuits 191 is set to 16, and each of the matching circuits 191 is associated with one of 16 antenna impedances VA, VB, . . . , VP shown in FIG. 3. The antenna impedances VA to VH are determined on a circle corresponding to a return loss of 6 dB. The antenna impedances VI to VP are determined on a circle corresponding to a return loss of 9 dB. The number of matching circuits 191 and characteristics of each matching circuit 191 may be appropriately determined by, for example, a designer of the reading device 100.

The matching adjustment unit 19 according to the present embodiment aims to achieve impedance matching so that the return loss is 14 dB or more. That is, an inside of a circle corresponding to the return loss of 14 dB in FIG. 3 is a control target range. If the return loss is 14 dB, a voltage standing wave ratio (VSWR) is approximately 1.5. Since Radio Law stipulates that the voltage standing wave ratio is to be 1.5 or more, it is appropriate to set the control target range for the return loss at 14 dB or more.

Each matching circuit 191 is configured to match an associated antenna impedance to 50 Ω (an origin in FIG. 3). Arrows in FIG. 3 indicate matching of the antenna impedance VL to 50 Ω. In the matching circuit 191 for matching the antenna impedance VL to 50 Ω in this manner, an inductance value of the inductor 1911 is LL in FIG. 3, and a capacitance value of the capacitor 1912 is CL in FIG. 3.

Next, an operation of the reading device 100 configured as described above will be described.

Before describing the operation, the self-interference signal and the cancelling thereof will be described.

The antenna duplexer 18 is designed so that a transmitted signal input to the input terminal TI is not output from the output terminal TOA. However, in an actual circuit configuration, it is difficult to completely prevent the transmitted signal input to the input terminal TI from leaking from the output terminal TOA. Therefore, a part of the transmitted signal input to the input terminal TI (hereinafter referred to as a leak signal) is output as it is from the output terminal TOA. A part of the transmitted signal output from the input and output terminal TIO of the antenna duplexer 18 is reflected at feeding point of the antenna 21 and transmitted to the antenna duplexer 18 via the feed line 20. Power of such a reflected signal increases as antenna impedance mismatching increases. Therefore, the power is hereinafter referred to as mismatch reflected power. Such a reflected signal is output from the output terminal TOA by a function of the antenna duplexer 18. Thus, the signal output from the output terminal TOA of the antenna duplexer 18 includes a composite signal of a leak signal component and a mismatch reflected power component. Such a composite signal is a self-interference signal. Since the leak signal and the reflected signal have an amplitude and a phase, respectively, an amplitude and a phase of the self-interference signal are determined as a magnitude and a direction of a composite vector of a leak signal vector and a reflected signal vector. The impedance of the antenna 21 changes according to an environment around the antenna 21, such as a proximity state of the RFID tag 200 and another object to the antenna 21. Therefore, an impedance matching state related to the antenna 21 also varies depending on the environment around the antenna 21, and the amplitude and phase of the self-interference signal also vary depending on the environment around the antenna 21.

The self-interference signal is a signal derived from the transmitted signal. Therefore, the self-interference signal in the received signal can be cancelled by combining the cancel signal generated by changing an amplitude and a phase of a signal branched off from the transmitted signal with the received signal output from the output terminal TOA of the antenna duplexer 18. In the reading device 100, the self-interference signal in the received signal is reduced by combining the cancel signal obtained by changing the amplitude and the phase using the variable attenuator 22 and the variable phase shifter 23 with the received signal output from the output terminal TOA of the antenna duplexer 18 by the power combiner 25. The processing is cancelling, which is hereinafter referred to as self-jammer cancellation (SJC).

Next, measuring the self-interference signal and the return loss will be described.

For example, in a state where the cancellation of the self-interference signal is stopped by stopping an output of the cancel signal from the variable phase shifter 23, if the carrier waves output from the oscillator 11 and the phase shifter 12 are supplied to the input terminal TI of the antenna duplexer 18 as they are, a level of an output signal from the quadrature detector 26 changes according to the self-interference signal. Therefore, the FPGA 322 performs predetermined calculation on the two-system received baseband signals in a digital state output from the AD converter 31, thereby determining the amplitude and phase of the self-interference signal.

A ratio of power of the carrier wave supplied to the input terminal TI of the antenna duplexer 18 to power of the leak signal is determined by characteristics of the antenna duplexer 18 and is constant. Therefore, if the power of the carrier wave supplied to the input terminal TI of the antenna duplexer 18 is constant, the power of the leak signal is also constant. Thus, an amplitude and a phase of the output signal from the quadrature detector 26 change according to the reflected signal. That is, there is a positive correlation between changes in amplitude and phase of the output signal from the quadrature detector 26 and the return loss. Therefore, the FPGA 322 determines the return loss based on the changes in the amplitude and phase of the output signal from the quadrature detector 26.

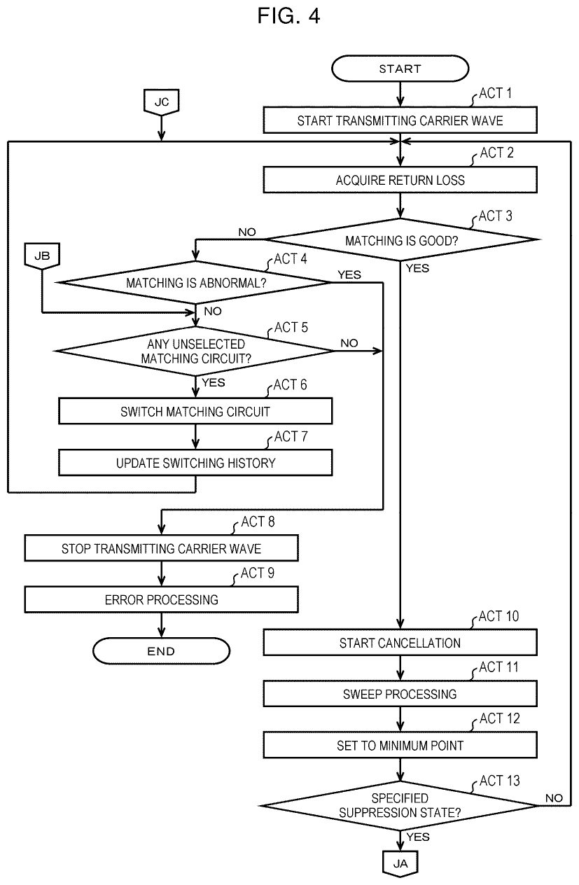

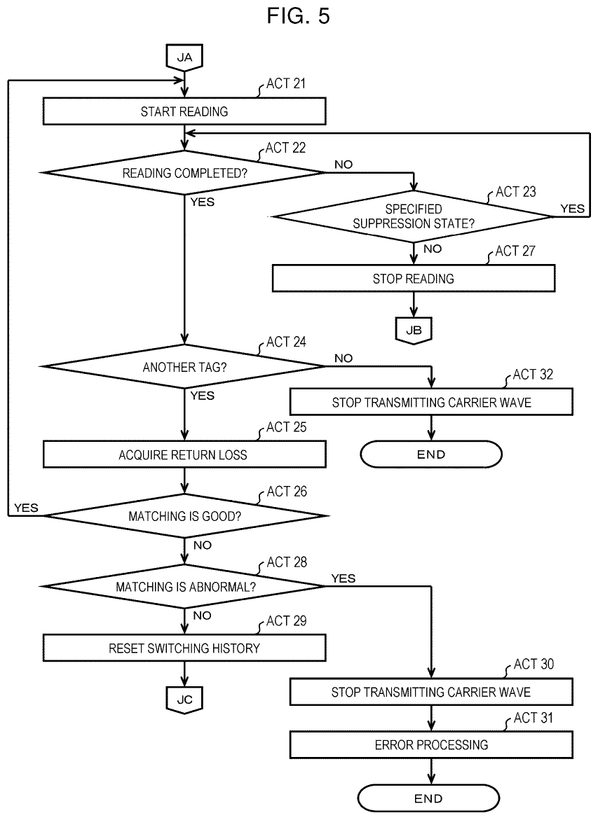

FIGS. 4 and 5 are flowcharts of the controlling.

If it is necessary to read the RFID tag 200, the CPU 321 executes the controlling shown in FIGS. 4 and 5 based on the control program PRA.

As ACT 1 in FIG. 4, the CPU 321 starts transmitting a carrier wave. That is, for example, the CPU 321 brings the quadrature modulator 14 into a state of outputting the carrier waves output from the oscillator 11 and the phase shifter 12 as they are.

In ACT 2, the CPU 321 acquires the latest determination result of a return loss by the FPGA 322.

In ACT 3, the CPU 321 checks whether impedance matching performed by the matching adjustment unit 19 is good. For example, the CPU 321 checks whether the return loss acquired in ACT 2 is within the control target range. If the return loss is out of the control target range, the CPU 321 determines the result as NO since the matching is not good, and proceeds to ACT 4.

At this time, the CPU 321 detects that the impedance matching related to the antenna 21 is in a predetermined mismatching state in which the return loss is not within the target range, and the CPU 321 has a function as a first detection unit.

In ACT 4, the CPU 321 checks whether the impedance matching by the matching adjustment unit 19 is abnormal. For example, the CPU 321 checks whether the return loss acquired in ACT 2 is within a predetermined abnormal range. The abnormal range may be, for example, “less than 6 dB” and may be appropriately determined by a designer of the reading device 100 or the like. If the return loss is out of the abnormal range, the CPU 321 determines NO as the matching is not abnormal, and proceeds to ACT 5.

In ACT 5, the CPU 321 checks whether there is a matching circuit 191 that is not selected while looping through ACT 2 to ACT 7 as described later. If the CPU 321 proceeds from ACT 1 to ACT 6 through ACT 2 to ACT 4, a matching circuit 191 other than the matching circuit 191 currently selected by the switches 192 and 193 is not selected. If there is such a matching circuit 191 that is not selected, the CPU 321 determines YES and proceeds to ACT 6.

In ACT 6, the CPU 321 switches the switches 192 and 193 so as to select the matching circuit 191 that is not selected.

In ACT 7, the CPU 321 updates a switching history. For example, the CPU 321 manages the switching history by storing, for example, in the memory 33, history data representing a list of matching circuits 191 that are selected among the matching circuits 191 in the matching adjustment unit 19, and updates the history data to add a matching circuit 191 most recently selected in ACT 6 to the list. Alternatively, the CPU 321 manages the switching history by storing, for example, in the memory 33, history data representing a list of matching circuits 191 that are not selected among the matching circuits 191 in the matching adjustment unit 19, and updates the history data to exclude a matching circuit 191 most recently selected in ACT 6 from the list.

Thereafter, the CPU 321 returns to ACT 2, and repeats the processing in the same manner as described above. Thus, the CPU 321 repeats the processing of checking the return loss while switching the matching circuit 191 until the impedance matching can be determined as good in ACT 3, the impedance matching can be determined as abnormal in ACT 4, or it cannot be determined that there is the unselected matching circuit 191 in ACT 5. When all the matching circuits 191 are selected by repeating the loop, if the CPU 321 does not determine that the impedance matching is good in ACT 3 or that the impedance matching is abnormal in ACT 4, the CPU 321 determines NO in ACT 5 and proceeds to ACT 8. If the return loss acquired in ACT 2 falls within the abnormal range, the CPU 321 determines that the impedance matching is abnormal, determines YES in ACT 4, and proceeds to ACT 8. If the CPU 321 proceeds to ACT 8 in this manner, the CPU 321 detects that the impedance matching related to the antenna 21 is in a predetermined difficult-to-match state in which it is difficult to form a good matching state by the matching adjustment unit 19, and thus has a function as a second detection unit.

In ACT 8, the CPU 321 stops transmitting the carrier wave.

In ACT 9, the CPU 321 executes error processing. For example, as the error processing, the CPU 321 executes processing to inform an operator that an environment is not appropriate for reading. As the error processing, the CPU 321 may execute other processing such as outputting an alarm sound or reproducing a voice message. The CPU 321 may execute a plurality of types of processing as the error processing. An operation such as a display for guidance associated with the error processing is performed by, for example, another information terminal. The reading device 100 may include an appropriate user interface device (not shown), and the user interface device may perform an operation such as display for guidance associated with the error processing. A content of the guidance given by the error processing may be different for a case where YES is determined in ACT 4 and a case where NO is determined in ACT 5. Thus, the CPU 321 has a function as a processing unit that executes the error processing. Upon completion of the error processing, the CPU 321 ends current control processing.

For example, if the return loss falls within the target range by impedance matching via the matching circuit 191 selected by the switches 192 and 193 at the start of the controlling or via the matching circuit 191 sequentially selected thereafter, the CPU 321 determines that the matching is good and determines YES in ACT 3, and proceeds to ACT 10. By controlling the switches 192 and 193 by the CPU 321 in this manner, the impedance of the antenna 21 is matched so as to eliminate a mismatching state. That is, the CPU 321 functions as a control unit. A function of the CPU 321 as the control unit and the matching adjustment unit 19 cooperate to implement a function of an adjustment unit.

In ACT 10, the CPU 321 starts cancellation. That is, the CPU 321 starts outputting a cancel signal from the variable phase shifter 23. The CPU 321 sets an attenuation amount of the variable attenuator 22 and a phase shift amount of the variable phase shifter 23 such that an amplitude and a phase of the cancel signal are set to predetermined initial values. The initial values of the amplitude and the phase of the cancel signal are determined within a predetermined sweep range. The sweep range is a range including an amplitude and a phase of the self-interference signal that may occur in a standard situation. The sweep range may be appropriately determined by, for example, a designer of the reading device 100.

In ACT 11, the CPU 321 sweeps the amplitude and phase of the cancel signal within the sweep range. That is, for example, the CPU 321 sequentially changes the attenuation amount of the variable attenuator 22 and the phase shift amount of the variable phase shifter 23 within a predetermined range according to the sweep range. Then, the CPU 321 determines the attenuation amount and the phase shift amount when a level of an output signal of the quadrature detector 26 becomes minimum.

In ACT 12, the CPU 321 sets operating states of the variable attenuator 22 and the variable phase shifter 23 to minimum points. That is, for example, the CPU 321 sets the amplitude and the phase of the cancel signal to the attenuation amount and the phase shift amount determined in ACT 11.

In ACT 13, the CPU 321 checks whether a state is a specified suppression state. The specified suppression state is a state in which an influence of the self-interference signal is sufficiently reduced. More specifically, as an example, a state in which a level of a component of the self-interference signal remaining in the output signal of the quadrature detector 26 (hereinafter, referred to as a residual signal) is reduced to −20 dB or less compared with that in a non-suppression state is defined as the specified suppression state. That is, the CPU 321 checks a suppression amount measured by the FPGA 322, and if it is confirmed that the suppression amount is reduced to −20 dB or less from a time of non-suppression, the CPU 321 determines that the state is the specified suppression state. The specified suppression state is preferably determined as a state in which a minimum suppression amount at which the quadrature detector 26 is not saturated due to an influence of the residual signal is obtained. The specified suppression state is appropriately determined by, for example, a designer of the reading device 100. For example, when the return loss is acquired last in ACT 2, the CPU 321 acquires the latest determination result related to the level of the output signal of the quadrature detector 26 by the FPGA 322, and uses the latest determination result as a level of the self-interference signal in the non-suppression state.

If the CPU 321 confirms that the state is not the specified suppression state, the CPU 321 determines NO in ACT 13 and repeats ACT 2 and the subsequent ACTs. That is, since there is a possibility that the antenna impedance matching is not good due to a change in a surrounding environment or the like, adjustment of the impedance matching described above is restarted.

If the CPU 321 confirms that the state is the specified suppression state, the CPU 321 determines YES in ACT 13 and proceeds to ACT 21 in FIG. 5.

If the carrier wave transmitted so far reaches the RFID tag 200, the RFID tag 200 starts generating operation power as rectified power based on the carrier wave.

In ACT 21, the CPU 321 starts reading the RFID tag 200. That is, the CPU 321 calls one RFID tag 200 activated as described above to transmit a response signal, and starts a series of sequences for receiving the response signal (hereinafter, referred to as a reading sequence). The reading sequence may be similar to that performed by another existing reading device, and a detailed description thereof will be omitted. Then, the CPU 321 shifts to a standby state in ACT 22 and ACT 23 while executing the reading sequence.

In ACT 22, the CPU 321 checks whether the reading of one RFID tag is completed. Then, if the CPU 321 cannot confirm the corresponding event, the CPU 321 determines NO, and proceeds to ACT 23.

In ACT 23, the CPU 321 confirms whether a state is the specified suppression state is set, for example, in the same manner as in ACT 13 in FIG. 4. If the specified suppression state remains, the CPU 321 determines YES, and returns to ACT 22.

Thus, in the standby state of ACT 22 and ACT 23, the CPU 321 waits for the reading to be completed or waits for the state to be no longer in the specified suppression state.

If the reading of one RFID tag 200 is completed, the CPU 321 determines YES in ACT 22 and proceeds to ACT 24.

In ACT 24, the CPU 321 checks whether there is another RFID tag 200 to be read. If there is the RFID tag 200 to be read, the CPU 321 determines YES and proceeds to ACT 25.

In ACT 25, the CPU 321 acquires the latest determination result of a return loss by the FPGA 322.

In ACT 26, the CPU 321 confirms whether the impedance matching by the matching adjustment unit 19 is good in the same manner as in ACT 3 in FIG. 4. If the CPU 321 confirms that the impedance matching is good, the CPU 321 determines YES, and repeats the processing after ACT 21 in the same manner as described above. That is, the CPU 321 attempts to read another RFID tag 200 to be read.

During execution of the reading sequence, the self-interference signal may change due to a change in the surrounding environment or the like, and the specified suppression state may not be maintained. In particular, if a communication speed is relatively low and a time required to execute the reading sequence (hereinafter, referred to as reading time) becomes long, there is a concern that the self-interference signal may greatly change during the execution of the reading sequence.

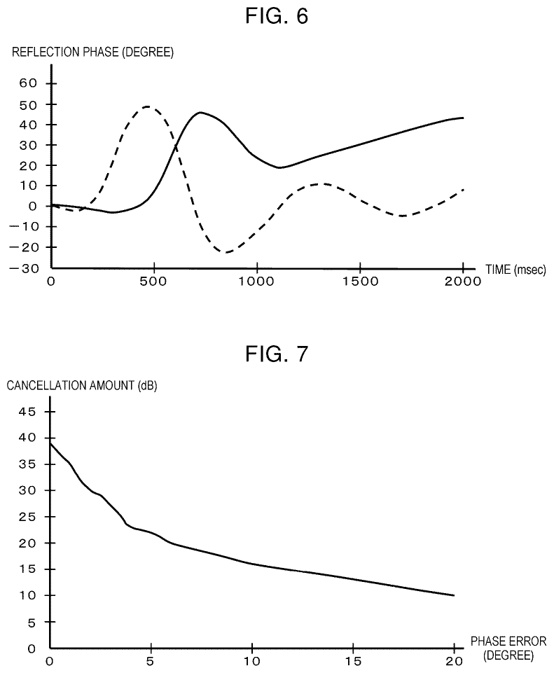

FIG. 6 is a diagram showing an actual measurement example of variations in a phase of a reflected signal over time.

FIG. 6 is an example of reading from the RFID tags 200 each attached to each of a plurality of articles placed on a shelf while moving the reading device 100. In FIG. 6, a solid line indicates a case where the reading device 100 is moved in a horizontal direction of the shelf, and a broken line indicates a case where the reading device 100 is moved in a vertical direction of the shelf.

FIG. 7 is a diagram showing an actual measurement example of a change in a cancellation amount due to a phase error.

It is desirable to secure a cancellation amount of 20 dB at minimum, and it is desirable to suppress the phase error within 5 degrees, as can be seen in FIG. 7.

On the other hand, in FIG. 6, if attention is paid to a portion where variations over time are steep, variations in the 5-degree reflection phase are observed in 31 msec from 524 msec to 555 msec. Therefore, if the reading of one RFID tag 200 is not completed within 31 msec, it is conceivable that the cancellation amount becomes insufficient during the reading and a reading error occurs.

The reading time for the RFID tag 200 depends on performance of the RFID tag 200. For example, if the RFID tag 200 is in an ultra high frequency (UHF) band conforming to the currently popular ISO/IEC 18000-63/EPCGEN2 standard, the reading time is about 6 msec (40 kbps, 240 bit length), which is within the above-described 31 msec.

However, if the RFID tag 200 is configured at a lower cost using print electronics technology or the like and requires a reading time of 100 msec or more, reading is not completed within the above-described 31 msec.

In particular, if the RFID tag 200 to be read is of such a low-speed type, there is a possibility that the specified suppression state cannot be maintained during execution of the reading sequence. Even if the reading time is short, if a steep environmental variation occurs within the reading time, there is a possibility that the specified suppression state cannot be maintained.

If the CPU 321 cannot confirm that the RFID tag 200 is in the specified suppression state before the reading of one RFID tag 200 is completed, the CPU 321 determines NO in ACT 23 in FIG. 5 and proceeds to ACT 27.

In ACT 27, the CPU 321 stops the reading sequence being executed. Thereafter, the CPU 321 repeats the processing of ACT 5 and thereafter in FIG. 4 in the same manner as described above.

On the other hand, if the CPU 321 cannot confirm that the impedance matching by the matching adjustment unit 19 is good after the reading of one RFID tag 200 is completed, the CPU 321 determines NO in ACT 26 and proceeds to ACT 28.

In ACT 28, the CPU 321 confirms whether the impedance matching by the matching adjustment unit 19 is abnormal in the same manner as in ACT 4 in FIG. 4. Then, if the CPU 321 cannot confirm that impedance matching is abnormal, the CPU 321 determines NO, and proceeds to ACT 29.

In ACT 29, the CPU 321 resets a switching history. For example, the CPU 321 updates history data so that it can be determined that only the matching circuit 191 selected by the switches 192 and 193 at this time point is selected. Alternatively, the CPU 321 may update the history data so that it can be determined that no matching circuit 191 is selected. Thereafter, the CPU 321 executes the processing after ACT 2 in FIG. 4 in the same manner as described above. Accordingly, the CPU 321 restarts the above-described impedance matching adjustment from the beginning.

In contrast, if the CPU 321 confirms that the impedance matching by the matching adjustment unit 19 is abnormal in ACT 28 in FIG. 5, the CPU 321 determines YES and proceeds to ACT 30. If the CPU 321 proceeds to ACT 30 in this manner, the CPU 321 detects that the impedance matching related to the antenna 21 is in a predetermined difficult-to-match state in which it is difficult to form a good matching state by the matching adjustment unit 19, and thus has a function as the second detection unit.

In ACT 30, the CPU 321 stops transmitting the carrier wave.

In ACT 31, the CPU 321 executes error processing as in ACT 9 in FIG. 4. At this time, the CPU 321 functions as the processing unit that executes the error processing. Upon completion of the error processing, the CPU 321 ends current control processing.

If reading of all the RFID tags 200 to be read is completed, the CPU 321 determines NO in ACT 24 in FIG. 5 and proceeds to ACT 32.

In ACT 32, the CPU 321 stops transmitting the carrier wave. Then, the CPU 321 ends current control processing.

As described above, if the mismatching state of the impedance matching related to the antenna 21 occurs due to a variation in the surrounding environment, the reading device 100 determines the mismatching state based on a change in the reflected signal, and performs the impedance matching by the matching adjustment unit 19 to achieve the matching state. Accordingly, even if the impedance of the antenna 21 varies, the impedance matching is performed to reduce the self-interference signal, and the self-interference signal can be appropriately cancelled by the SJC.

The reading device 100 can adjust the antenna impedance at high speed by switching the plurality of matching circuits 191 by the switches 192 and 193.

If the impedance matching by the matching adjustment unit 19 is not good even after all the matching circuits 191 in the matching adjustment units 19 are selected, that is, if the impedance cannot be adjusted by the matching adjustment unit 19 so as to make the impedance matching good, the reading device 100 may not be able to perform normal reading, so that an operator or the like is notified of the fact by the error processing. Accordingly, the operator or the like can take appropriate measures such as quickly taking measures such as improving the surrounding environment that causes the impedance variation.

If the impedance matching by the matching adjustment unit 19 is abnormal, the reading device 100 may not be able to perform normal reading, so that an operator or the like is notified of the fact by the error processing. Accordingly, the operator or the like can take appropriate measures such as quickly taking measures such as improving the surrounding environment that causes the impedance variation.

In the present embodiment, if the return loss is in an abnormal range of, for example, “less than 6 dB”, the CPU 321 determines that the impedance matching by the matching adjustment unit 19 is abnormal. If the return loss is 6 dB, 50% of power supplied to the antenna 21 is reflected at the antenna feeding point. Therefore, in a situation where the return loss is less than 6 dB, mismatch reflected power is large, and the power exceeds a maximum input (maximum rating) of a semiconductor element used in a receiving circuit, and there is a risk that the element is damaged. In some cases, a protection circuit is provided to prevent damage to the semiconductor element, but in such a case, a function of the protection circuit will cause the reading device 100 to not function. Therefore, it is appropriate to perform the error processing in a situation where the return loss is less than 6 dB.

The embodiment can be modified in various ways as follows.

The embodiment may be implemented as a communication device that communicates with a wireless tag such as the RFID tag 200 for the purpose different from the purpose of reading data stored in the RFID tag 200 from the RFID tag 200.

Each function implemented by the CPU 321 through the information processing can also be implemented in part or in whole by hardware that executes information processing not based on a program, such as a logic circuit. Each of the above functions can be implemented by combining software control with hardware such as the above logic circuit.

While certain embodiments have been described, these embodiments have been presented by way of example only, and are not intended to limit the scope of the exemplary embodiments. These novel embodiments can be implemented in various other forms, and various omissions, substitutions, and modifications can be made without departing from the gist of the disclosure. The embodiments and the modifications thereof are included in the scope and the spirit of the disclosure, and are included in a scope of the invention disclosed in the claims and equivalents thereof.

What is claimed is:

1. A communication device for receiving a response wave emitted from a wireless tag based on a received carrier wave, the communication device comprising:
an antenna;
a first generation component configured to generate a carrier wave;
a duplexer configured to receive the carrier wave generated by the first generation component from an input terminal and output the carrier wave to the antenna from an input and output terminal, and output a signal input from the antenna to the input and output terminal from an output terminal;
a second generation component configured to generate a cancel signal by changing an amplitude and a phase of the carrier wave generated by the first generation component;
a suppression component configured to suppress a self-interference signal in an output signal from the output terminal by using the cancel signal generated by the second generation component;
a first detector configured to detect that impedance matching related to the antenna is in a predetermined mismatching state; and
an adjustment component configured to adjust, in response to detection of a mismatching state by the first detector, an antenna impedance to eliminate the mismatching state.

2. The communication device according to claim 1, wherein
the adjustment component includes
a plurality of matching circuits each configured to match different antenna impedances to a predetermined impedance when connected to the antenna,
a switch configured to selectively insert the plurality of matching circuits between the input and output terminal and the antenna, and
a controller configured to control the switch to select a matching circuit from the plurality of matching circuits for which the mismatching state is no longer detected by the first detector.

3. The communication device according to claim 1, wherein
the adjustment component matches an antenna impedance during a period in which the response wave emitted from the wireless tag is not received.

4. The communication device according to claim 1, wherein
the second generation component determines an amount of change in amplitude and phase for generating the cancel signal after the antenna impedance is adjusted by the adjustment component.

5. The communication device according to claim 1, further comprising:
a second detector configured to detect a predetermined difficult-to-match state in which impedance matching related to the antenna is difficult; and
a processor configured to perform predetermined error processing in response to detection of a difficult-to-match state by the second detector.

6. The communication device according to claim 1, wherein
the first generation component comprises at least one of an oscillator and a phase shifter.

7. The communication device according to claim 1, further comprising:
a variable phase shifter configured to change a phase of a transmitted signal attenuated by a variable attenuator by a phase shift amount corresponding to a phase shift amount setting signal.

8. The communication device according to claim 1, wherein
the second generation component comprises at least one of a variable attenuator and a variable phase shifter.

9. A communication method for receiving a response wave emitted from a wireless tag based on a received carrier wave, the communication method comprising:
generating a carrier wave;
receiving by a duplexer the carrier wave generated by a first generation component from an input terminal and output the carrier wave to an antenna from an input and output terminal, and outputting a signal input from the antenna to the input and output terminal from an output terminal;
generating a cancel signal by a second generation component by changing an amplitude and a phase of the carrier wave generated by the first generation component;
a suppression component configured to suppressing a self-interference signal in an output signal from the output terminal by using the cancel signal generated by the second generation component;
a first detector configured to detecting that impedance matching related to the antenna is in a predetermined mismatching state; and
an adjustment component configured to adjusting, in response to detection of a mismatching state, an antenna impedance to eliminate the mismatching state.

10. The communication device according to claim 9, further comprising:
matching, by a plurality of matching circuits, different antenna impedances to a predetermined impedance when connected to the antenna;
selectively inserting the plurality of matching circuits between the input and output terminal and the antenna; and
selecting a matching circuit from the plurality of matching circuits for which the mismatching state is no longer detected.

11. The communication device according to claim 9, further comprising:
matching an antenna impedance during a period in which the response wave emitted from the wireless tag is not received.

12. The communication device according to claim 9, further comprising:
determining an amount of change in amplitude and phase for generating the cancel signal after the antenna impedance is adjusted.

13. An RFID reading device for receiving a response wave emitted from a RFID tag based on a received carrier wave, the RFID reading device comprising:
an antenna;
a first generation component configured to generate a carrier wave;
a duplexer configured to receive the carrier wave generated by the first generation component from an input terminal and output the carrier wave to the antenna from an input and output terminal, and output a signal input from the antenna to the input and output terminal from an output terminal;
a second generation component configured to generate a cancel signal by changing an amplitude and a phase of the carrier wave generated by the first generation component;
a suppression component configured to suppress a self-interference signal in an output signal from the output terminal by using the cancel signal generated by the second generation component;
a first detector configured to detect that impedance matching related to the antenna is in a predetermined mismatching state; and
an adjustment component configured to adjust, in response to detection of a mismatching state by the first detector, an antenna impedance to eliminate the mismatching state.

14. The RFID reading device according to claim 13, wherein
the adjustment component includes
a plurality of matching circuits each configured to match different antenna impedances to a predetermined impedance when connected to the antenna,
a switch configured to selectively insert the plurality of matching circuits between the input and output terminal and the antenna, and
a controller configured to control the switch to select a matching circuit from the plurality of matching circuits for which the mismatching state is no longer detected by the first detector.

15. The RFID reading device according to claim 13, wherein
the adjustment component matches an antenna impedance during a period in which the response wave emitted from the RFID tag is not received.

16. The RFID reading device according to claim 13, wherein
the second generation component determines an amount of change in amplitude and phase for generating the cancel signal after the antenna impedance is adjusted by the adjustment component.

17. The RFID reading device according to claim 13, further comprising:
a second detector configured to detect a predetermined difficult-to-match state in which impedance matching related to the antenna is difficult; and
a processor configured to perform predetermined error processing in response to detection of a difficult-to-match state by the second detector.

18. The RFID reading device according to claim 13, wherein
the first generation component comprises at least one of an oscillator and a phase shifter.

19. The RFID reading device according to claim 13, further comprising:
a variable phase shifter configured to change a phase of a transmitted signal attenuated by a variable attenuator by a phase shift amount corresponding to a phase shift amount setting signal.

20. The RFID reading device according to claim 13, wherein
the second generation component comprises at least one of a variable attenuator and a variable phase shifter.
